(19) United States
(12) Patent Application Publication
(10) Pub. No.: US 2001/0053072 A1
(43) Pub. Date: Dec. 20, 2001

(54) Planar light source apparatus having simplified configuration and providing uniform and high brightness and liquid crystal display unit including the same

(76) Inventor: Takahiro Takemoto, Tokyo (JP)

Correspondence Address: Paul J. Esatto, Jr., Scully, Scott, Murphy & Presser, 400 Garden City Plaza, Garden City, NY, 11530, US

(21) Appl. No.: 09/741,507

(22) Filed: Dec. 19, 2000

(30) Foreign Application Priority Data
Dec. 24, 1999 (JP) 368226/1999

(51) Int. Cl. F21V 7/04

(52) U.S. Cl. 362/31

(57) ABSTRACT

A planar light source apparatus includes a plurality of light sources, and a plurality of illumination units. The plurality of illumination units are arranged adjacently to each other between the plurality of light sources and a target illuminated by the plurality of light sources. The plurality of light sources are arranged to illuminate edge portions of the plurality of illumination units, respectively.

### BACKGROUND OF THE INVENTION

1. Field of the Invention

The present invention relates to a planar light source apparatus and a liquid crystal display unit includes the same.

2. Description of the Related Art

Conventionally, a planar light source apparatus, especially a planar light source apparatus used for a liquid crystal display unit is installed on the rear face of a liquid crystal panel as a backlight for clearly displaying information displayed on the liquid crystal panel to users.

A cold cathode fluorescent lamp (CCFL) is widely used as a light source for the planar light source apparatus. The planar light source apparatus using this light source is structured as a box type or an edge-light type.

FIG. 1A is a sectional view of a conventional liquid crystal display unit having a box type planar light source apparatus.

FIG. 1B is a sectional view of a conventional liquid crystal display unit having an edge-light planar light source apparatus.

As shown in FIG. 1A, a box type planar light source apparatus 3 is provided with a frame 4 having a liquid crystal panel 2 for providing high brightness. On the rear face of this panel, there is provided a plurality of light sources 5 parallel arranged at a specified interval.

The frame 4 comprises a front chassis 4a, a center chassis 4b, and a rear chassis 4c. The front chassis 4a and the center chassis 4b hold the liquid crystal panel 2. The rear chassis 4c houses the light source 5 together with the center chassis 4b.

The front chassis 4a and the center chassis 4b are shaped like a frame with an opening for accepting light from a display area on the liquid crystal panel 2 and from the light source 5. The rear chassis 4c is shaped like a tray.

Between an inner base of the rear chassis 4c and the light source 5, there is provided a reflector 7 for effectively reflecting light from the light source 5 toward the liquid crystal panel 2. Between the light source 5 and the liquid crystal panel 2, there is provided a diffuser panel 6.

Here, the rear face of the liquid crystal panel 2 corresponds to the opposite side of an image display side of the liquid crystal panel 2 when the liquid crystal panel 2 is mounted on the liquid crystal display unit 1. This also applies to the following description.

The rear chassis 4c is one of members constituting the frame 4 of the liquid crystal display unit 1. The rear chassis 4c is a member constituting the frame 4 as well as the front chassis 4a and the center chassis 4b which sandwich the liquid crystal panel 2.

This box type structure is provided with a plurality of light sources 5. This structure is advantageous to improvement of high brightness for the liquid crystal display unit 1, but easily causes irregular brightness. To solve this, it is necessary to provide a given gap between the liquid crystal panel 2 and the light source 5.

Since the box type structure provides a given gap between the liquid crystal panel 2 and the light source 5, the liquid crystal display unit 1 requires a sufficient thickness and time-consuming surface processing is needed for the diffuser panel 6. In recent years, further improvement has been requested for thinning the liquid crystal display unit 1.

The edge-light type structure is employed as a backlight structure for thinning liquid crystal display units.

As the edge-light type structure, the liquid crystal panel's rear face is provided with a light guide plate made of highly transparent resin. A columnar CCFL is provided as a light source at the tip of the light guide plate.

The edge-light type structure has been using a wedge-shaped light guide plate so that a section of the light guide plate becomes thinner as departing from the light source.

As shown in FIG. 1B in detail, the liquid crystal panel 2's rear face is provided with a nearly dish-shaped rear chassis 4c whose opening faces the liquid crystal panel 2. The rear chassis 4cs bottom is provided with a wedge-shaped light guide plate 31.

The diffuser panel 6 is provided between the light guide plate 31 and the liquid crystal panel 2. A light blocking plate 8 is provided around the light source 5 except where the light guide plate 31 is placed.

Highly transparent acrylic resin or methacrylic resin is used as a material for the light guide plate 31.

The following describes a planar light source apparatus having the wedge-shaped light guide plate described in Japanese Patent Application Laid-Open Publication No. 7-36037 with reference to the accompanying drawings.

FIGS. 1C and 1D are sectional views of the configuration of the planar light source apparatus disclosed in Japanese Laid Open Patent Application (JP-A-Heisei, 7-36037).

As shown in FIG. 1C, the light source 5 has a U-shaped form so that it covers sides of the light guide plate 31.

It is proposed that using the thus configured light source increases an amount of light passing through the light guide plate. Also, according to the disclosure, it is possible to provide an edge-light type planar light source apparatus having a highly bright illuminating face.

As shown in FIG. 1D, the light source 5 is shared by two wedge-shaped light guide plates 31. It is proposed that such a configuration makes it possible to circularly arrange light guide plates 31 around the light source 5, for example, for providing a circular planar light source apparatus.

According to the disclosure, such a configuration can provide a thin planar light source apparatus by effectively irradiating light from a single light source to a plurality of light guide plates.

In recent years, large-sized liquid crystal display units are preferred for improved visibility. Planar light source apparatuses need to be large-sized accordingly.

High brightness is the primary requirement for planar light source apparatus built in large-sized liquid crystal display units. For this purpose, box type planar light source apparatuses have been widely used because a light source is light-weight and is easily added.

There is an increasing demand for thin a large-sized liquid crystal display unit. However, it is difficult to thin a box type planar light source apparatus.

There may be a technology for providing a large-sized, highly bright edge-light type planar light source apparatus which is designed for a thin form and uniform brightness. Such a technology can effectively provide high-quality liquid crystal display units.

FIG. 1C or 1D shows a conventional structure of an edge-light type planar light source apparatus. When such a structure is used for a large liquid crystal display unit, the light source 5 and the light guide plate 31 need to be large-sized.

There is a possibility of examining a design using a plurality of modular configurations each of which comprises the light source 5 and the light guide plate 31.

In this case, there is a spatial limitation on placing each modular configuration. It has been difficult to arrange the sufficient number of modular configurations for providing high brightness.

Consequently, there arises a problem that it is impossible to provide sufficient brightness due to the limited number of light sources.

The planar light source apparatus in FIG. 1D may be used for a large liquid crystal display unit. In this case, a plurality of the modular configurations in FIG. 1C is arranged as shown in FIG. 1D.

There is provided a plurality of parallel placed configurations for irradiating a plurality of light guide plates with a single light source. Therefore, it is possible to relatively easily provide high brightness by improving the efficient use of an installation space.

The planar light source apparatus as shown in FIG. 1D causes the brightness just above and under the light source 5 to be excessively higher than that on the surface of the light guide plate 31. This impairs brightness uniformity which is an essential characteristic of the edge-light type planar light source apparatus.

### SUMMARY OF THE INVENTION

The present invention has been made in consideration of the foregoing. It is therefore an object of the present invention to provide a planar light source apparatus having a simplified configuration and providing uniform and high brightness and a liquid crystal display unit includes the same.

In order to achieve an aspect of the present invention, a planar light source apparatus, includes: a plurality of light sources; and a plurality of illumination units arranged adjacently to each other between the plurality of light sources and a target illuminated by the plurality of light sources, and wherein the plurality of light sources are arranged to illuminate edge portions of the plurality of illumination units, respectively.

In this case, the edge portions include incidence planes of light by the plurality of light sources.

Also in this case, each of the plurality of illumination units overlaps with each other such that a surface of a first illumination unit of the plurality of illumination units is placed opposite to a rear face of a second illumination unit of the plurality of illumination units.

Further in this case, the light source illuminates the edge portion of the first illumination unit and at least one portion of the rear face of the second illumination unit.

In this case, a single substantially flat face is formed with the plurality of illumination units and the single substantially flat face is opposed to the target.

In order to achieve another aspect of the present invention, a planar light source apparatus, includes: a plurality of light sources; and a plurality of wedge-shaped illumination units having edge portions, wherein a thickness of each of the plurality of wedge-shaped illumination units decreases as departing from the edge portion, the plurality of light sources illuminating the edge portions.

In this case, each of the plurality of illumination units overlaps with each other such that a surface of a first illumination unit of the plurality of illumination units is placed opposite to a rear face of a second illumination unit of the plurality of illumination units.

Also in this case, the light source illuminates the edge portion of the first illumination unit and at least one portion of the rear face of the second illumination unit.

Further in this case, a single substantially flat face is formed with the plurality of illumination units and the single substantially flat face is opposed to a target illuminated by the plurality of light sources.

In this case, at least one of the surface of the first illumination unit and the rear face of the second illumination unit is processed for controlling a light volume when the light source illuminates the target.

Also in this case, the each of plurality of illumination units overlaps with each other in an overlapping portion of the each of plurality of illumination units, and wherein a gradation process is applied to the overlapping portion by changing the number of dots formed per unit area of the overlapping portion.

Further in this case, a planar light source apparatus further includes: a casing provided along external periphery portions of the plurality of light sources and the plurality of illumination units.

In this case, a planar light source apparatus further includes: a supporting member to support the illumination unit, wherein the supporting member is provided between the illumination unit and the casing.

Also in this case, the supporting member is made of the same material as the illumination unit.

Further in this case, the supporting member and the illumination unit are substantially formed in one piece.

In this case, the illumination unit includes a light guide plate.

Also in this case, the light guide plate is made of highly transparent resin.

In order to achieve still another aspect of the present invention, a liquid crystal display apparatus, includes: a liquid crystal panel; and a planar light source unit provided in a rear side of the liquid crystal panel, and wherein the planar light source unit includes: a plurality of light sources; and a plurality of illumination units arranged adjacently to each other between the plurality of light sources and the liquid crystal panel, and wherein the plurality of light sources are arranged to illuminate edge portions of the plurality of illumination units, respectively.

In this case, the edge portions include incidence planes of light by the plurality of light sources.

Also in this case, each of the plurality of illumination units overlaps with each other such that a surface of a first illumination unit of the plurality of illumination units is placed opposite to a rear face of a second illumination unit of the plurality of illumination units.

For solving the above-mentioned problems, a planar light source apparatus of the present invention is characterized as follows. Two or more illumination units are arranged adjacently to each other between a light source and an irradiation object. The light source is arranged so that an edge of each illumination unit is used as an incidence plane.

Such a configuration allows an illumination unit to be placed just above the light source, controlling light from the light source against an irradiation object. Also, it is possible to easily uniform brightness on the surface of each illumination unit.

Since illumination units are arranged adjacently, it is possible to place many light sources to be provided for each illumination unit. Accordingly, it is possible to provide uniform high brightness across a wide illuminating face. Here, the irradiation object is referred to as an object irradiated by a planar light source apparatus. With respect to a planar light source apparatus installed in a liquid crystal display unit, a liquid crystal panel is equivalent to an irradiation object.

An illumination unit surface corresponds to a face of each illumination unit opposite to the irradiation object.

Accordingly, an opposite face of the illumination unit surface is referred as a rear face of the illumination unit.

The illuminating face is opposite to an irradiation object and is formed on a planar light source apparatus which directly illuminates the irradiation object.

With respect to a planar light source apparatus installed in the liquid crystal display unit, for example, the illuminating face means a face parallel to the rear face of the liquid crystal panel. Further, the illuminating face is illuminated by a light source in the planar light source apparatus.

For solving the above-mentioned problems, a planar light source apparatus of the present invention is characterized as follows. Each illumination unit overlaps with each other so that the surface of one illumination unit is placed opposite the rear face of another illumination unit. The light source is arranged so that the edge of the one illumination unit is used as an incidence plane and at least part of the rear face of the other illumination unit is used as an incidence plane.

The above-mentioned configuration can not only control a light volume just above each light source, but also highly integrate illumination units constituting the planar light source apparatus.

Using an illumination unit having a thin section can thin the planar light source apparatus based on a simple configuration.

Accordingly, it is possible to provide a wide illuminating face with high brightness and a thin form.

For solving the above-mentioned problems, a planar light source apparatus of the present invention is characterized as follows. Two or more illumination units each partially form a nearly flat face opposite an irradiation object.

This configuration can easily control uniform brightness on the illuminating face of the planar light source apparatus which comprises assembled parts of illumination units.

Forming a nearly flat illuminating face can effectively irradiate light to an irradiation object.

Here, the illuminating face means a series of faces which comprise assembled parts of illumination units and are placed opposite an irradiation object.

For solving the above-mentioned problems, a planar light source apparatus of the present invention is characterized as follows. There are provided two or more wedge-shaped illumination units whose thickness decreases as departing from an incidence plane for edge light. Each illumination unit overlaps with each other so that the surface of one illumination unit is placed opposite the rear face of another illumination unit. The surface of each illumination unit forms almost a series of faces opposite an irradiation object. A light source is arranged on a light incidence plane one or more illumination units.

Such a configuration allows an illumination unit to be placed just above the light source, controlling light from the light source against an irradiation object. Also, it is possible to easily uniform brightness on the surface of each illumination unit.

Since illumination units are arranged adjacently, it is possible to place many light sources to be provided for each illumination unit. Accordingly, it is possible to provide uniform high brightness across a wide illuminating face.

For solving the above-mentioned problems, a planar light source apparatus of the present invention is characterized as follows. At least either the illumination unit's surface or the illumination unit's rear face is processed for controlling a light volume of the light source which illuminates an irradiation object.

This configuration can provide high brightness using two or more light sources and uniform brightness of the planar light source apparatus's illuminating face.

Here, the above-mentioned processing for controlling a light volume of the light source means processing applied to the illumination unit's surface and rear face for uniforming brightness of a given area on an illuminating face of a planar light source apparatus includes two or more light sources and two or more illumination units.

Specifically, such processing includes the light blocking, the light volume attenuation and diffusion. An experiment or the like is conducted beforehand to yield brightness distribution data on an illuminating face. Based on this data, any of the above-mentioned processing is applied to a given area.

For solving the above-mentioned problems, a planar light source apparatus of the present invention is characterized as follows. The rear face of one illumination unit overlaps with another illumination unit. To an overlapping area, gradation processing is applied by forming dots based on print area sizes per unit area.

This configuration can control a light interference and the like due to a plurality of light sources and uniform brightness on an illuminating face of the planar light source apparatus.

Here, an area for which the gradation is processed is determined by a planar light source apparatus size, a light volume due to two light sources, an illumination unit shape, and the like.

With respect to the planar light source apparatus, for example, it is assumed that the maximum in-plane brightness is Lmax; the minimum in-plane brightness is Lmin; and the average in-plane brightness is Lavr.

As a technique for decreasing a value of ∥Lmax-Lavr∥, the gradation is performed as follows along an optical path from the light source to the illuminating face.

1) When the gradation is applied on a reflecting area:

A reflecting area is decreased per unit area near the light source.

A reflecting area is increased per unit area far away from the light source.

2) When the gradation is applied on a transparent area:

A transparent area is decreased per unit area near the light source.

A transparent area is increased per unit area far away from the light source.

As mentioned above, relieving the brightness unevenness makes it possible to control the Lmax/Lmin value so that it can meet the brightness unevenness specification.

For solving the above-mentioned problems, a planar light source apparatus of the present invention is characterized as follows. An illumination unit comprises two or more members whose surface is processed with at least one of the dot processing, the light volume attenuation, and the light blocking.

This configuration can adjust brightness near the light source and uniform brightness on the illuminating face.

Especially, the brightness near the light source is extremely higher than that for the other areas. Processing for attenuating a light volume of the light source or the light blocking is applied to the vicinity of the light source, namely, a given area toward the illuminating face from the light source.

The above-mentioned given area is experimentally assumed so that the uniform brightness can be provided for any area on an illuminating face, namely, a face includes assembled parts of illumination units. The light volume attenuation or the light blocking is experimentally chosen with respect to each of the above-mentioned given areas so that any area on the illuminating face can have uniform brightness.

When thus processed two or more members constitute a single illumination unit, a joint area is formed for decreasing a load during the light volume attenuation or the light blocking.

Especially, uniforming the brightness near the light source results in uniforming the brightness on an illuminating face of the planar light source apparatus.

For example, the light blocking is applied near the light source over the light guide plate's surface or rear face. Preferably, a filter or the like is provided in order to attenuate the light source volume.

For solving the above-mentioned problems, a planar light source apparatus of the present invention is characterized as follows. An illumination unit comprises two or more members whose rear face is processed with at least one of the dot processing, the light volume attenuation, and the light blocking.

This configuration can adjust the brightness near the light source and can uniform the brightness on the illuminating face.

For solving the above-mentioned problems, a planar light source apparatus of the present invention is characterized as follows. There is formed at least one of a dot processing layer, a light volume attenuation layer, and a light blocking layer on at least part of the inside or the surface of an illumination unit.

This configuration resolves brightness unevenness near each light source caused by simply installing a plurality of illumination units. It is therefore possible to provide high brightness and uniform brightness across a wide illuminating face.

The planar light source apparatus of the present invention uses a plurality of light sources. In such a planar light source apparatus, it is effective to apply processing such as gradation to at least part of the inside or the surface of an illumination unit for further uniforming brightness on an illuminating face of the planar light source apparatus.

For solving the above-mentioned problems, a planar light source apparatus of the present invention is characterized as follows. There is formed at least one of a dot processing layer, a light volume attenuation layer, and a light blocking layer on at least part of the inside or the rear face of an illumination unit.

This configuration resolves brightness unevenness near each light source caused by simply installing a plurality of illumination units. It is therefore possible to provide high brightness and uniform brightness across a wide illuminating face.

Especially, dots and the like are formed so that a light volume is decreased near the light source on the illumination unit's rear face and the brightness is uniformed far away from the light source.

A range of the illumination unit's rear face to which this processing is applied is experimentally found so that the illuminating face brightness is uniformed. This range is also determined by a planar light source apparatus size and specifications of the light source and the other members.

The above-mentioned illumination unit inside is applicable when the light source's light control processing is applied to two or more joint areas and the like and these sections are joined to form a single illumination unit.

For solving the above-mentioned problems, a planar light source apparatus of the present invention is characterized as follows. A frame is formed along external peripheries of illumination units and the light source.

This configuration can firmly fix each illumination unit and increase a frame's surface area, thus effectively radiating heat generated from the planar light source apparatus.

For solving the above-mentioned problems, a planar light source apparatus of the present invention is characterized as follows. A supporting member is provided for supporting illumination units so that the supporting member is sandwiched between the illumination unit and the frame.

This configuration can firmly fix the illumination unit and the light source and resolve the reflectivity uncertainty due to an air space. Consequently, it is possible to provide a planar light source apparatus with stable brightness maintained.

For solving the above-mentioned problems, a planar light source apparatus of the present invention is characterized as follows. A supporting member is made of almost the same material as an illumination unit.

Because the supporting member is made of almost the same material as an illumination unit, a brightness loss can be prevented on the planar light source apparatus's illuminating face, improving efficiency as the planar light source apparatus.

For solving the above-mentioned problems, a planar light source apparatus of the present invention is characterized as follows. An illumination unit and the supporting member are formed in one piece.

Since an illumination unit and the supporting member are formed in one piece, the illumination unit is firmly fixed in the planar light source apparatus, stabilizing efficiency as the planar light source apparatus.

For solving the above-mentioned problems, a planar light source apparatus of the present invention is characterized as follows.

Illumination units are formed in one piece with each other.

Since illumination units are formed in one piece with each other, handleability as the planar light source apparatus is improved.

For solving the above-mentioned problems, a planar light source apparatus of the present invention is characterized as follows. An illumination unit is a light guide plate made of highly transparent resin.

An illumination unit comprises a single light source and a light guide plate made of highly transparent resin. Because of this, light from the light source can effectively reach an illuminating face of the planar light source apparatus. The light guide plate shape makes it possible to provide simple installation of an illumination unit.

For solving the above-mentioned problems, a liquid crystal display unit of the present invention is characterized as follows. A planar light source apparatus described in any one of claims 1 through 16 is mounted on the rear face of a liquid crystal panel.

This configuration can provide a liquid crystal display unit having a large, thin, and highly bright display area.

The present invention uses a wedge-shaped illumination unit 100 which becomes thinner as departing from an edge light's incidence plane. Two or more illumination units 100 are arranged by placing the surface of one illumination unit 100 opposite the rear face of another illumination unit 100 so that respective illumination units 100 partially overlap with each other. The surface of each illumination unit 100 forms almost a series of faces opposite an irradiation object. A light source 5 is placed on a light incidence plane for one or more illumination units 100.

### BRIEF DESCRIPTION OF THE DRAWINGS

FIG. 1A is a sectional view showing a conventional structure of a liquid crystal display unit having a box type planar light source apparatus;

FIG. 1B is a sectional view showing a conventional structure of a liquid crystal display unit having an edge-light type planar light source apparatus;

FIG. 1C is a perspective view showing an example of a planar light source apparatus having a wedge-shaped light guide plate;

FIG. 1D is a sectional view showing another example of a planar light source apparatus having a wedge-shaped light guide plate;

FIG. 2 is a sectional view showing a structure of a planar light source apparatus and a liquid crystal display unit having the same according to a first embodiment of the present invention;

FIG. 3 is an enlarged view of FIG. 2;

FIG. 4 is a sectional view showing a modification for a structure of a planar light source apparatus and a liquid crystal display unit having the same according to a first embodiment of the present invention;

FIG. 5 is a sectional view showing another modification for a structure of a planar light source apparatus and a liquid crystal display unit having the same according to a first embodiment of the present invention;

FIG. 6 is a sectional view showing a structure of a planar light source apparatus and a liquid crystal display unit having the same according to a second embodiment of the present invention;

FIG. 7 is an enlarged view of FIG. 6;

FIG. 8 is a sectional view showing a modification for a structure of a planar light source apparatus and a liquid crystal display unit having the same according to a second embodiment of the present invention;

FIG. 9 is a sectional view showing another modification for a structure of a planar light source apparatus and a liquid crystal display unit having the same according to a second embodiment of the present invention;

FIG. 10 is a sectional view showing a structure of a planar light source apparatus and a liquid crystal display unit having the same according to a third embodiment of the present invention;

FIG. 11 is an enlarged view of FIG. 10;

FIG. 12 is a sectional view showing a modification for a structure of a planar light source apparatus and a liquid crystal display unit having the same according to a third embodiment of the present invention;

FIG. 13 is a sectional view showing another modification for a structure of a planar light source apparatus and a liquid crystal display unit having the same according to a third embodiment of the present invention; and

FIG. 14 is an enlarged view of FIG. 8.

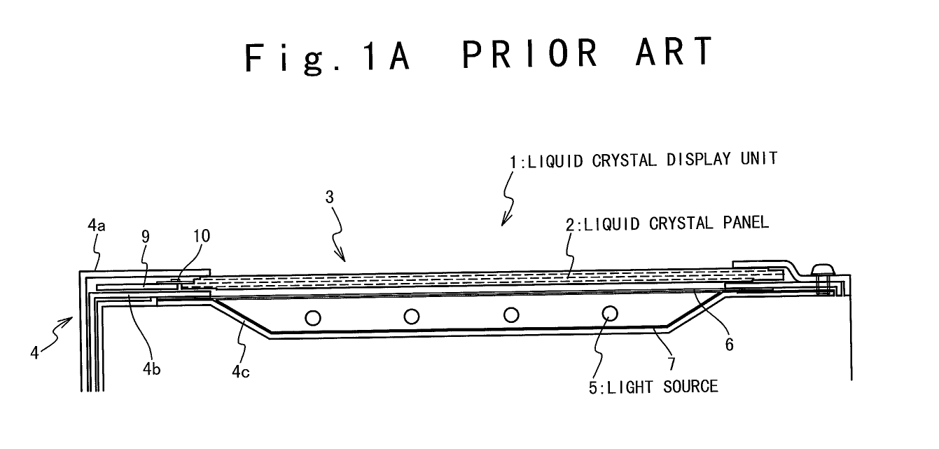

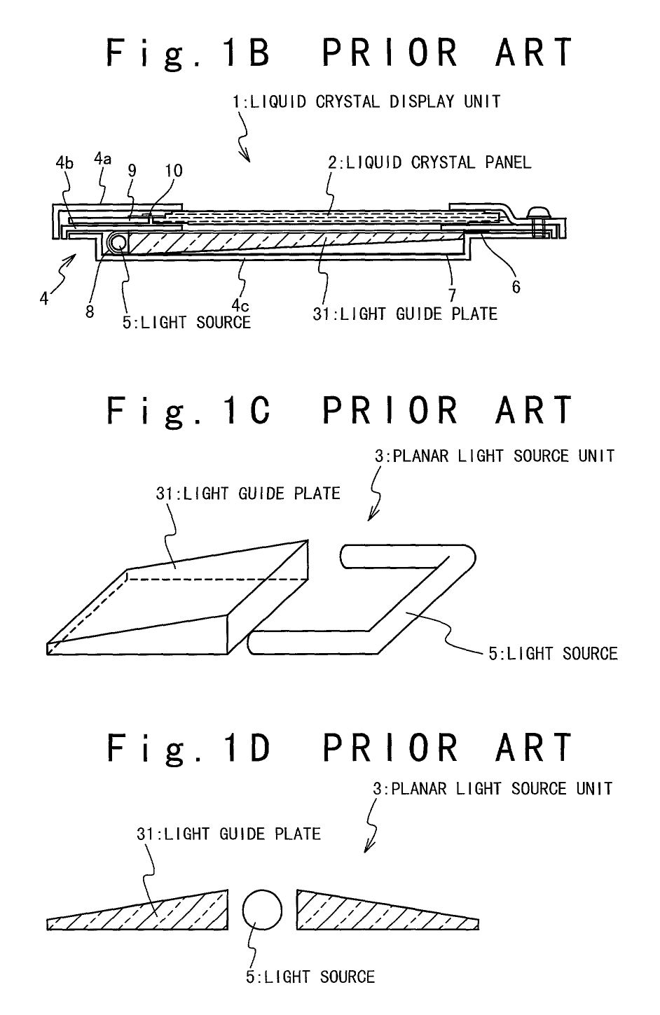

### DESCRIPTION OF THE PREFERRED EMBODIMENTS

An embodiment of a semiconductor memory apparatus in the present invention will be described below in detail with reference to the attached drawings.

### First Embodiment

The first embodiment of a planar light source apparatus and a liquid crystal display unit having the same according to the present invention will be described in further detail with reference to the accompanying drawings.

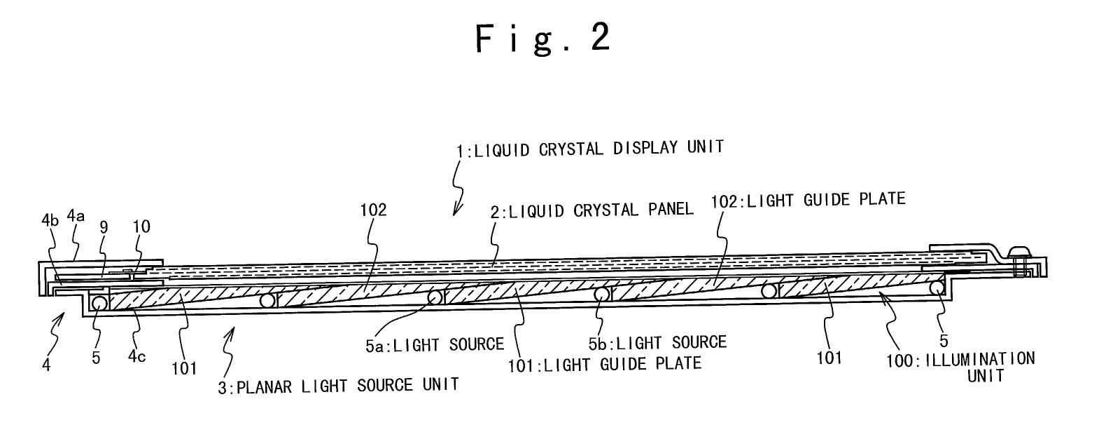

FIG. 2 is a sectional view showing a structure of a planar light source apparatus and a liquid crystal display unit having the same according to the first embodiment of the present invention.

As shown in FIG. 2, a liquid crystal display unit 1 having a planar light source apparatus according to the first embodiment comprises a planar light source apparatus 3, a liquid crystal panel 2, and a frame 4 holding the planar light source apparatus 3 and the liquid crystal panel 2.

The frame 4 comprises a front chassis 4a and a center chassis 4b holding the liquid crystal panel 2 and a rear chassis 4c holding the planar light source apparatus 3 together with the center chassis 4b.

The front chassis 4a and the center chassis 4b are shaped like a frame with an opening for ensuring a light source from a display area on the liquid crystal panel 2 and from the planar light source apparatus 3. The rear chassis 4c is shaped like a tray.

The front chassis 4a and the center chassis 4b form a space near one end of the liquid crystal panel 2. In this space, a connection substrate 9 is installed and is connected to the liquid crystal panel 2 via a TCP (Tape Carrier Package) 10.

As regards the planar light source apparatus according to this embodiment, the liquid crystal display unit 1 contains a plurality of the light sources 5 and the illumination units 100 arranged in the same direction so that these are sandwiched between the liquid crystal panel 2 and the rear chassis 4c.

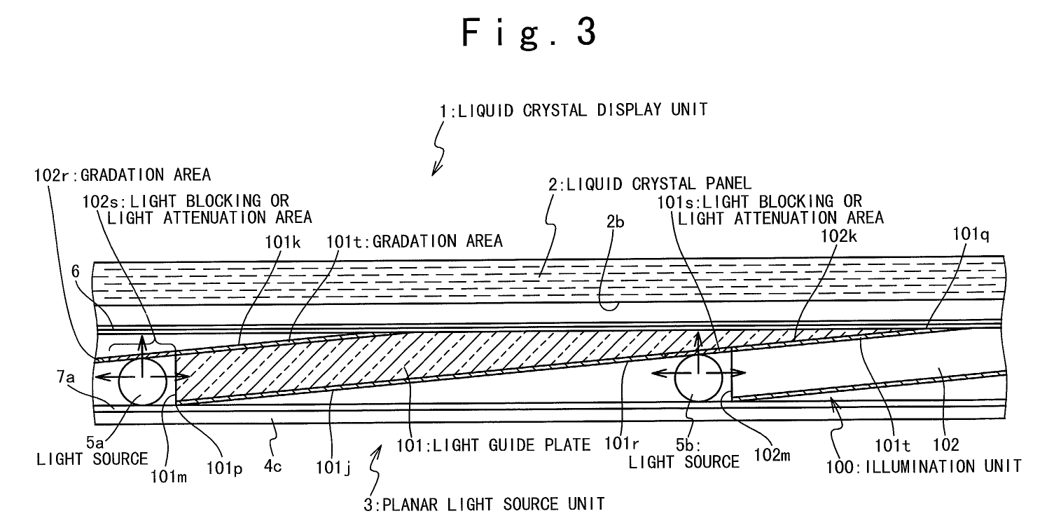

FIG. 3 is a sectional view showing a liquid crystal display unit equipped with the planar light source apparatus according to the first embodiment of the present invention and is enlarged at one illumination unit.

The illumination unit 100 comprises a wedge-shaped light guide plate 101 or 102. The light guide plates 101 and 102 have the same configuration and material. Namely, the light guide plates 101 and 102 each are same members. For an explanation purpose, however, adjacent light guide plates are indicated with numerals 101 and 102.

At the rear of each light guide plate 101 or 102, the light source 5a is sandwiched between the light guide plate 102 (adjacent to another light guide plate 101) and the rear chassis 4c. The light source 5b is sandwiched between the light guide plate 101 (adjacent to another light guide plate 102) and the rear chassis 4c.

The light guide plate 101 or 102 uses such a material as resin which is highly transparent to visible light. It is desirable to use acrylic resin or methacrylic resin.

The light guide plates 101 and 102 overlap with each other so that a rear face 101j of the light guide plate 101 partially touches a surface 102k of the light guide plate 102.

Here, a surface 101k of the wedge-shaped light guide plate 101 means a face opposite the rear face 101j of the liquid crystal panel 2. A face opposite the surface 101k of the wedge-shaped light guide plate 101 is assumed to be the rear face 101j of the light guide plate 101.

A back face 101m of the light guide plate 101 means a face which belongs to a face linking the surface 101k and the rear face 101j of the light guide plate 101, but does not constitute nearly flat faces opposite the rear face 2b of the liquid crystal panel 2.

The light guide plate 101 is provided with a base edge 101p which is located at an edge on a back face 101m of the light guide plate 101 with respect to the surface 101k or the rear face 101j of the light guide plate 101. The light guide plate 101 is provided with a tip 101q which is located opposite to the base edge 101p.

Alternatively, the tip 101q corresponds to an edge at which the light guide plate 101's surface 101k touches the rear face 101j.

For uniforming brightness on the illuminating face, a light source 5 is provided at both ends (left and right ends) of the rear chassis 4c in FIG. 2.

Accordingly, the light source 5 is provided between the illumination unit 100's back face or the illumination unit 100 and the rear chassis 4c.

The following describes an illumination unit configuration of the planar light source apparatus and the liquid crystal display unit having the same according to the first embodiment the present invention with reference to FIG. 3. The following description chiefly centers on a configuration of two light guide plates adjacent to each other.

As shown in FIG. 3, the light guide plate 101's rear face 101j is processed with gradation and light blocking or light attenuation at specified areas. These processes are conducted for preventing light interference and the like from light sources 5a and 5b to uniform brightness on the liquid crystal panel 2.

On the light guide plate 101's rear face 101j, numeral 101r indicates an area where gradation is processed. Numeral 101s indicates an area where light volume attenuation is processed.

On the light guide plate 101's rear face 101j, a gradation area 101r is formed from the light guide plate 101's base edge 101p to the vicinity of the light source 5b installed near a back face 102m of the light guide plate 102. For example, dots are printed as gradation on the gradation area 101r.

On the light guide plate 101's rear face 101j, light blocking or light attenuation is applied to an area 101s over the light source 5b which is installed near the light guide plate 102's back face 102m. This area is hereafter referred to as the light blocking or light attenuation area 101s.

For these processes, dots and the like are formed on the light guide plate 101.

Alternatively, a layer for controlling a light source 5's light volume may be formed on the light guide plate 101.

The light source 5b is installed near the light guide plate 102's back face 102m over the light guide plate 101's rear face 101j. A gradation area 101t can be formed from the vicinity of this light source 5b to the light guide plate 101's tip 101q. Namely, this area 101t corresponds to an area other than the gradation area 101r and the light blocking or light attenuation area 101s over the light guide plate 101's rear face 101j. Gradation is reapplied to the area 101t by printing dots, for example.

The areas 101r and 101t to which gradation is applied are determined by a planar light source apparatus size, a light volume from the light sources 5a and 5b, a shape of the light guide plate 101, and the like.

With respect to the planar light source apparatus, for example, it is assumed that the maximum in-plane brightness is Lmax; the minimum in-plane brightness is Lmin; and the average in-plane brightness is Lavr. As a technique for decreasing a value of ∥Lmax-Lavr∥, the gradation is performed as follows along an optical path from the light source to the illuminating face.

1) When the gradation is applied on a reflecting area:

A reflecting area is decreased per unit area near the light source.

A reflecting area is increased per unit area far away from the light source.

2) When the gradation is applied on a transparent area:

A transparent area is decreased per unit area near the light source.

A transparent area is increased per unit area far away from the light source.

As mentioned above, relieving the brightness unevenness makes it possible to control the Lmax/Lmin value so that it can meet the brightness unevenness specification.

In the rear face 101j of the light guide plate 101, the light blocking is applied to the area 101s over the light source 5b. Preferably, a filter or the like is provided in order to attenuate a light volume of the light source 5b.

A gradation process is applied to the area 101t from the vicinity of the light source 5b to the light guide plate 101's tip 101q on the light guide plate 101's rear face 101j. This gradation process for the area 101t is almost same as that for the area 101j near the base edge 101p of the light guide plate 101.

As mentioned above, process modes for the light guide plate 101's rear face 101j depend on an experiment and the like conducted for uniforming brightness within a given range on an illuminating face. The illuminating face is formed opposite the liquid crystal panel 2 and comprises surfaces of a plurality of overlapping light guide plates 101 and 102.

Here, the process modes for the light guide plate 101's rear face 101j signify dot formation areas, dot distribution, respective dot shapes, and the like in the gradation process.

The process modes for the rear face 101j indicate a range of an area for forming dots and the like, transmittance of the dot formation area, and the like in the light blocking or light attenuation process.

Further, only dots may be screen-printed on at least either the light guide plate 101's surface 101k or rear face 101j. It is possible to determine the dot distribution and dot shapes so that uniform brightness is available on a given area of the illuminating face.

In the first embodiment of the planar light source apparatus and the liquid crystal display unit having the same according to the present invention, it may be preferable to provide a filler member 106 so that it is sandwiched between the illumination unit 100 and the rear chassis 4c. In this case, the filler member 106 can be a light guide illumination plate.

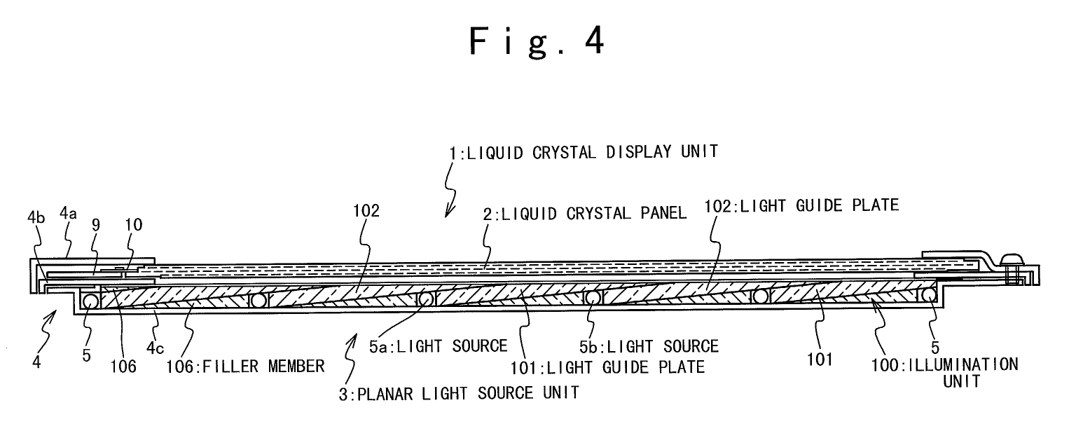

For details, a configuration in FIG. 4 uses a filler member 106 for the illumination unit 100. Specifically, the filler member 106 is inserted between a space formed by the light guide plate 101 or 102's rear face and the rear chassis 4c. The filler member 106 is made of almost the same material as for the light guide plate 101 or 102.

According to this configuration, the filler member 106 can reliably support each light guide plate 101 or 102 and provide a high-strength liquid crystal display unit.

Further, as shown in FIG. 4, it may be preferable to install the filler member 106 so that it is sandwiched between the left-most illumination unit 100 in the planar light source apparatus 3 and the center chassis 4b.

For the filler member 106 in this case, it is also possible to use a cutoff of the right-most illumination unit 100 (light guide plate 101 or 102) in the planar light source apparatus 3 according to this embodiment as shown in FIGS. 2 and 3.

Using the filler member prevents unexpected irregular reflection due to light from the light source 5 entering through an air space and precisely uniform brightness on the illuminating face.

The rear chassis 4c may be formed along an external periphery of each illumination unit for reliably supporting each illumination unit 100 and providing a high-strength liquid crystal display unit.

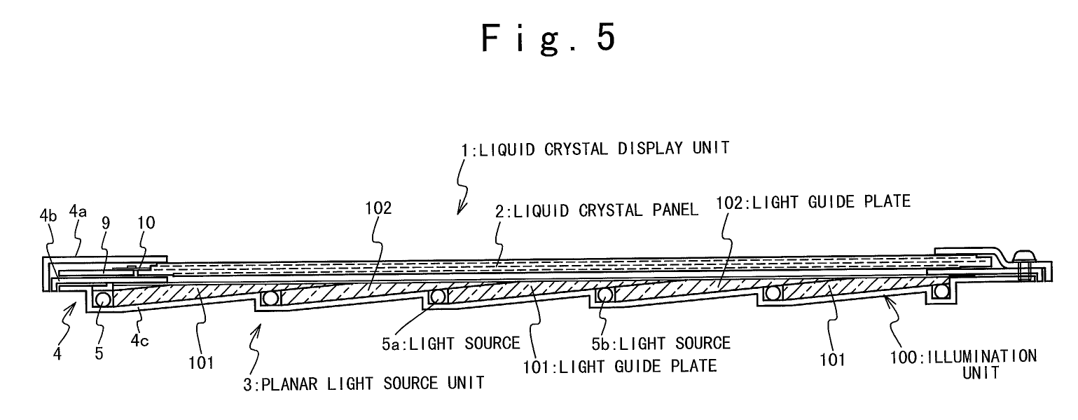

According to a configuration in FIG. 5, for details, the rear chassis 4c supports the light source 5 and the light guide plate 101 or 102 so that the rear chassis 4c covers the illumination unit 100.

According to this configuration, the rear chassis 4c can reliably support each illumination unit 100 and provide a light-weight and high-strength liquid crystal display unit.

Although not shown, it may be preferable to mold the light guide plate 101 or 102 and the filler member 106 into one piece. This structure can minimize light refraction at an interface between two adjacent light guide plates 101 and 102.

In the first embodiment of the planar light source apparatus and the liquid crystal display unit having the same according to the present invention, it is also possible to modify light source positions and the number of light sources as needed for providing high brightness and uniform brightness on the illuminating face.

### Second Embodiment

The second embodiment of a planar light source apparatus and a liquid crystal display unit having the same according to the present invention will be described in further detail with reference to the accompanying drawings.

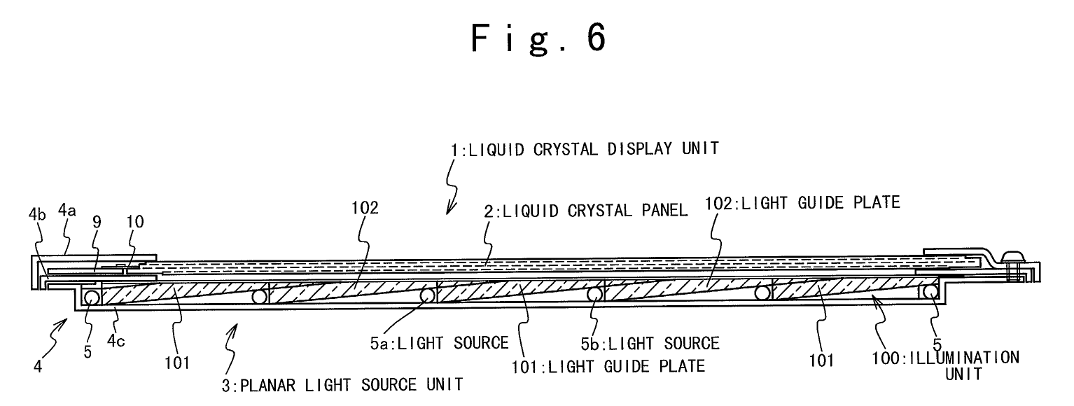

FIG. 6 is a sectional view showing a structure of a planar light source apparatus and a liquid crystal display unit having the same according to the second embodiment of the present invention.

As shown in FIG. 6, the liquid crystal display unit 1 having the planar light source apparatus according to the second embodiment comprises the planar light source apparatus 3, the liquid crystal panel 2, and the frame 4 holding the planar light source apparatus 3 and the liquid crystal panel 2.

The frame 4 comprises a front chassis 4a and a center chassis 4b holding the liquid crystal panel 2 and a rear chassis 4c holding the planar light source apparatus 3 together with the center chassis 4b.

The front chassis 4a and the center chassis 4b are shaped like a frame with an opening for ensuring a light source from a display area on the liquid crystal panel 2 and from the planar light source apparatus 3. The rear chassis 4c is shaped like a tray.

The front chassis 4a and the center chassis 4b form a space near one end of the liquid crystal panel 2. In this space, a connection substrate 9 is installed and is connected to the liquid crystal panel 2 via a TCP 10.

As regards the planar light source apparatus 3 according to this embodiment, the liquid crystal display unit 1 contains a plurality of the light sources 5 and the illumination units 100 so that these are sandwiched between the liquid crystal panel 2 and the center chassis 4b.

Here, the illumination unit 100 used for the planar light source apparatus according to the second embodiment comprises by dividing the light guide plate 101 according to the first embodiment.

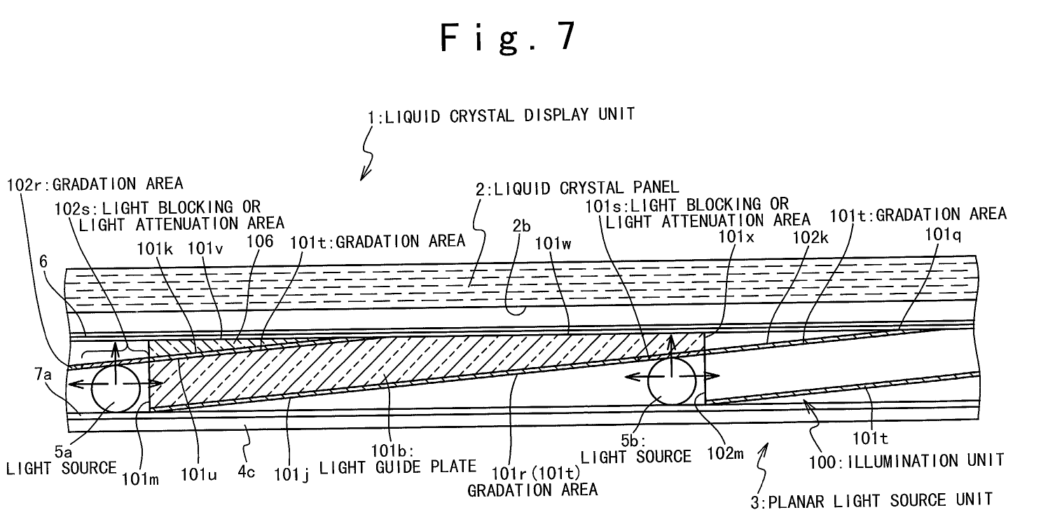

FIG. 7 is a sectional view showing a liquid crystal display unit equipped with the planar light source apparatus according to the second embodiment of the present invention and is enlarged at one illumination unit.

As shown in FIG. 7, the light guide plate 101 is cut in the illumination unit 100. A rear face 101u of the light guide plate 101a at the tip is stuck to the surface 101k of the light guide plate 101b at the back face 101m.

Specifically, when the light guide plate 101 is cut at a specified position, a tip becomes the light guide plate 101a. The remaining part becomes the light guide plate 101b.

Accordingly, the illumination unit 100 used for the planar light source apparatus according to the second embodiment of the present invention comprises the light guide plate 101b whose surface 101k is stuck to the rear face 101u of the light guide plate 101a.

The light guide plate 101a has a surface 101v. The light guide plate 101b has a surface 101w where the light guide plate 101a is not stuck. These surfaces 101v and 101w face the liquid crystal panel 2 at equal intervals.

It is desirable to cut the light guide plate 101 at a face 101x which is an extension along the back face 102m of the light guide plate 102 toward the liquid crystal panel 2.

The illumination unit 100 is so shaped that it maintains stability with respect to the center chassis 4b. Since the illumination unit 100's tip is cut, respective illumination units 100 can be easily connected to each other.

Since installability in the liquid crystal display unit 1 is improved, it is possible to easily assemble the liquid crystal display unit 1.

Given areas on the illumination unit 100 in FIG. 7 are preprocessed with the same treatment (gradation, light blocking or light volume attenuation) as for the light guide plate 101 or 102 used for the planar light source apparatus according to the first embodiment.

Accordingly, treatments such as gradation and the like (see the reference numeral 101t) are applied to the rear face and the inside of the illumination unit 100. The illumination unit 100 gives same effects as for the planar light source apparatus 3 and the liquid crystal display unit 1 having the same according to the first embodiment.

Like the planar light source apparatus 3 and the liquid crystal display unit having the same according to the first embodiment, it may be preferable to provide the filler member 106 so that it is sandwiched between the illumination unit 100 and the rear chassis 4c.

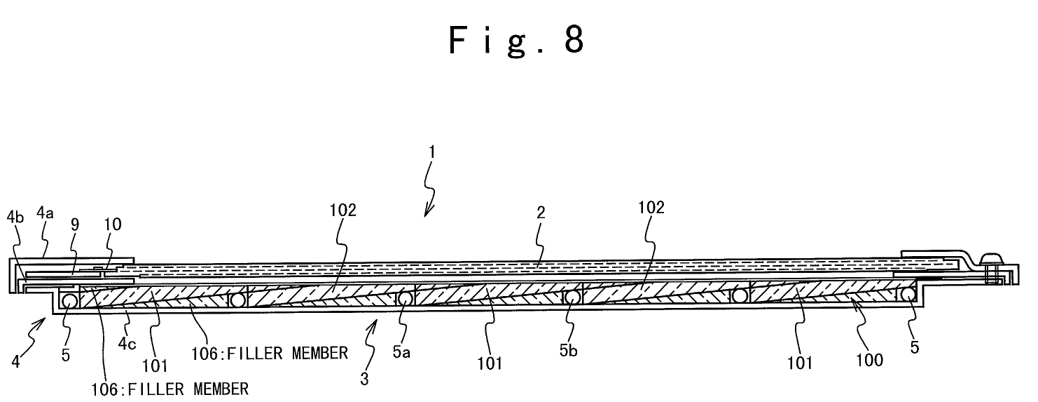

For details, a configuration in FIGS. 8 and 14 uses the filler member 106 for the illumination unit 100. Specifically, the filler member 106 is inserted between a space formed by the light guide plate 101 or 102's rear face and the rear chassis 4c. The filler member 106 is made of almost the same material as for the light guide plate 101 or 102. In this case, the filler member 106 can be a light guide plate. According to this configuration, the filler member 106 can reliably support each light guide plate 101 or 102 and provide a high-strength liquid crystal display unit. In FIG. 14, each of the symbols 101r and 101g denote the gradation area, and the symbol 101s denotes the light blocking or light attenuation area.

Further, as shown in FIGS. 7, 8, and 9, it may be preferable to install the filler member 106 so that it is sandwiched between the left-most illumination unit 100 in the planar light source apparatus 3 and the center chassis 4b.

For the filler member 106 in this case, it is also possible to use a cutoff of the right-most illumination unit 100 in the planar light source apparatus 3 according to this embodiment as shown in FIGS. 6, 8, and 9.

Using the filler member prevents unexpected irregular reflection due to light from the light source 5 entering through an air space and precisely uniform brightness on the illuminating face.

The rear chassis 4c may be formed along an external periphery of each illumination unit 100 for reliably supporting each illumination unit 100 and providing a high-strength liquid crystal display unit.

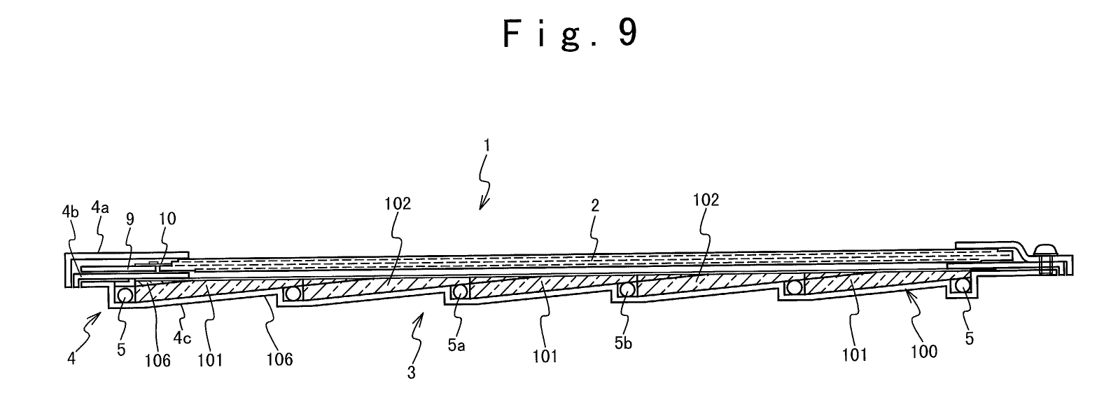

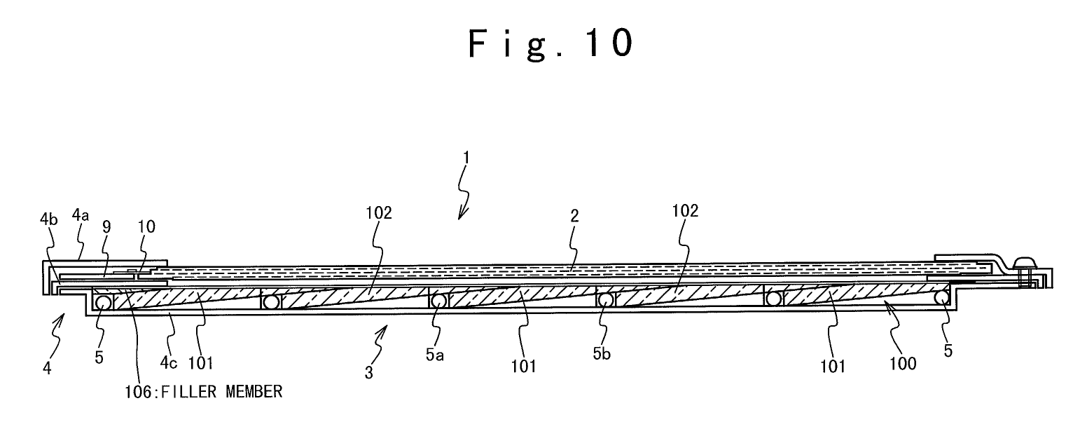

According to a configuration in FIG. 9, for details, the rear chassis 4c supports the light source 5 and the light guide plate 101 or 102 so that the rear chassis 4c covers the illumination unit 100.

According to this configuration, the rear chassis 4c can reliably support each illumination unit 100 and provide a light-weight and high-strength liquid crystal display unit.

Although not shown, it may be preferable to mold the light guide plate 101 or 102 and the filler member 106 into one piece. This structure can minimize light refraction at an interface between two adjacent light guide plates 101 and 102.

In the first embodiment of the planar light source apparatus and the liquid crystal display unit having the same according to the present invention, it is also possible to modify light source positions and the number of light sources as needed for providing high brightness and uniform brightness on the illuminating face.

### Third Embodiment

The third embodiment of a planar light source apparatus and a liquid crystal display unit having the same according to the present invention will be described in further detail with reference to the accompanying drawings.

As shown in FIG. 10, the liquid crystal display unit 1 having the planar light source apparatus according to the second embodiment comprises the planar light source apparatus 3, the liquid crystal panel 2, and the frame 4 holding the planar light source apparatus 3 and the liquid crystal panel 2.

The frame 4 comprises a front chassis 4a and a center chassis 4b holding the liquid crystal panel 2 and a rear chassis 4c holding the planar light source apparatus 3 together with the center chassis 4b.

The front chassis 4a and the center chassis 4b are shaped like a frame with an opening for ensuring a light source from a display area on the liquid crystal panel 2 and from the planar light source apparatus 3. The rear chassis 4c is shaped like a tray.

The front chassis 4a and the center chassis 4b form a space near one end of the liquid crystal panel 2. In this space, a connection substrate 9 is installed and is connected to the liquid crystal panel 2 via a TCP 10.

As regards the planar light source apparatus 3 according to this embodiment, the liquid crystal display unit 1 contains a plurality of the light sources 5 and the illumination units 100 so that these are sandwiched between the liquid crystal panel 2 and the center chassis 4b.

The illumination unit 100 is so shaped that it maintains stability with respect to the center chassis 4b. Since the illumination unit 100's tip is cut, respective illumination units 100 can be easily connected to each other.

Since installability in the liquid crystal display unit 1 is improved, it is possible to easily assemble the liquid crystal display unit 1.

Here, like the second embodiment of the present invention, the illumination unit 100 used for the planar light source apparatus according to the third embodiment comprises by dividing the illumination unit 100 according to the first embodiment.

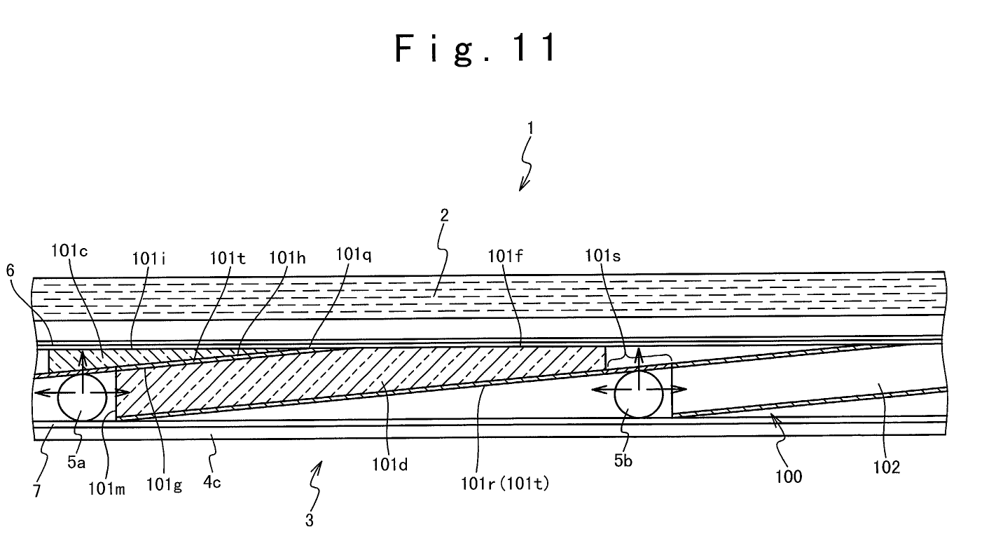

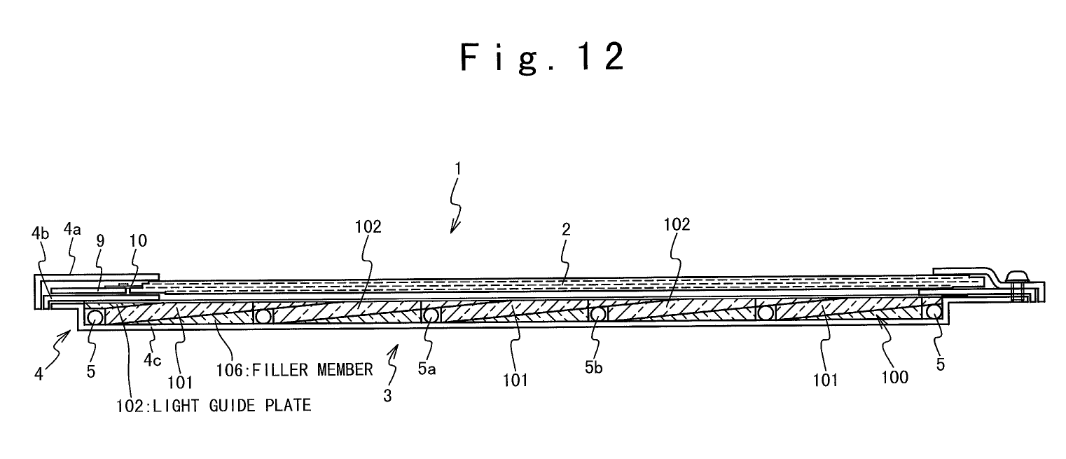

FIG. 11 is a sectional view showing a liquid crystal display unit equipped with the planar light source apparatus according to the first embodiment of the present invention and is enlarged at one illumination unit.

As shown in FIG. 11, a light guide plate 101d is formed by cutting the light guide plate 101 in FIG. 2 at a specified position. A light guide plate 101c is a cutoff from the light guide plate 101d. Part of the rear face 101g is stuck to a surface 101h of the light guide plate 101d.

It is desirable to specify the above-mentioned position to cut the light guide plate 101 in FIG. 2 as follows. Namely, when the light guide plate 101c cut from the light guide plate 101d is stuck to the light guide plate 101d, the light guide plate 101c covers the light source 5a positioned near the back face 101m of the light guide plate 101d.

As shown in FIG. 11, the illumination unit 100 used for the planar light source apparatus according to the third embodiment comprises the light guide plate 101c and the light guide plate Namely, the light guide plate 101c is set as follows. A length from the tip 101q of the light guide plate 101 before cutting to the end of the light guide plate 101c includes an area covering the light source 5a placed opposite the liquid crystal panel 2.

The light guide plate 101d is formed by eliminating the thus specified light guide plate 101c from the light guide plate 101 before cutting.

Accordingly, the illumination unit 100 used for the planar light source apparatus according to the third embodiment of the present invention comprises the light guide plate 101d whose surface 101h is stuck to the light guide plate 101c.

The light guide plate 101c has a surface 101i. The light guide plate 101d has a surface 101f where the light guide plate 101c is not stuck. These surfaces 101u and 101f face the liquid crystal panel 2 at equal intervals.

The illumination unit according to the third embodiment is so shaped that the shape of the light guide plate constituting the illumination unit covers the light source 5a placed at the illumination unit 100's back face for the sake of the liquid crystal panel 2.

Given areas on the illumination unit 100 in FIG. 11 are preprocessed with the same treatment as for the light guide plate 101 or 102 used for the planar light source apparatus according to the first embodiment.

Accordingly, treatments such as gradation and the like (see the reference numeral 101t) are applied to the rear face and the inside of the illumination unit 100. The illumination unit 100 gives same effects as for the planar light source apparatus and the liquid crystal display unit having the same according to the first embodiment.

Like the planar light source apparatus 3 and the liquid crystal display unit having the same according to the first embodiment, it may be preferable to provide the filler member 106 so that it is sandwiched between the illumination unit 100 and the rear chassis 4c.

For details, a configuration in FIG. 12 uses the filler member 106 and the light guide plate 102 for the illumination unit 100. Specifically, the filler member 106 is inserted between a space formed by the light guide plate 101d's rear face and the rear chassis 4c. The filler member 106 is made of almost the same material as for the light guide plate 101 or 102.

According to this configuration, the filler member 106 can reliably support each light guide plate 101d and provide a high-strength liquid crystal display unit 1.

Further, it may be preferable to install the filler member 106 so that it is sandwiched between the left-most illumination unit 100 in the planar light source apparatus 3 according to this embodiment and the center chassis 4b as shown in FIGS. 10, 12, and 13.

For the filler member 106 in this case, it is also possible to use a cutoff of the right-most illumination unit 100 in the planar light source apparatus 3 according to this embodiment as shown in FIGS. 10, 12, and 13.

Using the filler member prevents unexpected irregular reflection due to light from the light source 5 entering through an air space and precisely uniform brightness on the illuminating face.

The rear chassis 4c may be formed along an external periphery of each light source 5 and each illumination unit 100 for reliably supporting each illumination unit 100 and providing a high-strength liquid crystal display unit.

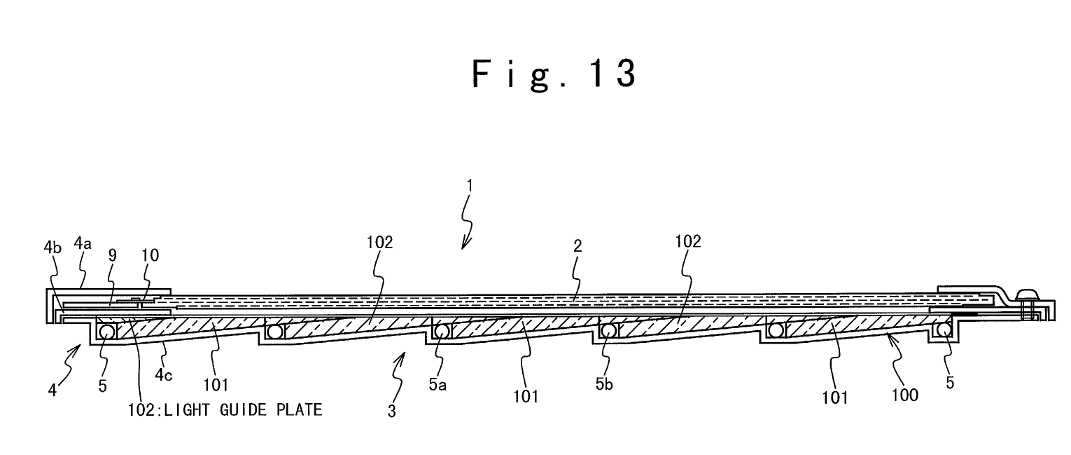

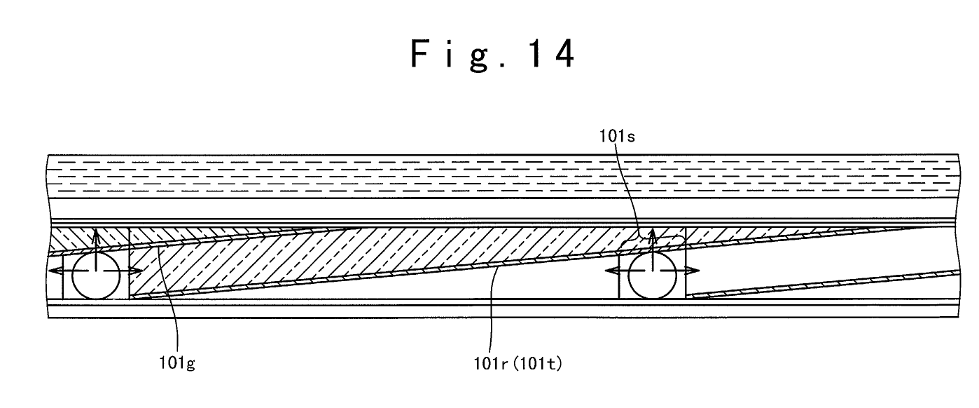

According to a configuration in FIG. 13, for details, the rear chassis 4c supports the light source 5 and the light guide plate 101 or 102 so that the rear chassis 4c covers the illumination unit 100.

According to this configuration, the rear chassis 4c can reliably support each illumination unit 100 and provide a light-weight and high-strength liquid crystal display unit.

Although not shown, it may be preferable to mold the light guide plate 101 or 102 and the filler member 106 into one piece. This structure can minimize light refraction at an interface between two adjacent light guide plates 101 and 102.

As described above, in this embodiment of the planar light source apparatus and the liquid crystal display unit having the same according to the present invention, it is also possible to modify illumination unit shapes, light source positions, and the number of light sources as needed for providing high brightness and uniform brightness on the illuminating face.

As mentioned above, the planar light source apparatus and the liquid crystal display unit having the same according to the present invention can provide a large size planar light source apparatus and a liquid crystal display unit having the same with high and uniform brightness.

Since members in the planar light source apparatus are provided as illumination units, it is possible to simplify the configuration and drastically decrease works for manufacturing processes.

This advantage is remarkable when compared to a configuration having increased light sources. This is because the configuration according to the present invention is simply a large-size or high-brightness version of a single illumination unit, namely a planar light source apparatus includes one light guide plate.

The liquid crystal display unit 1 having the planar light source apparatus according to the present invention is especially effective for an 18-inch or larger liquid crystal display.

The planar light source apparatus according to the present invention has been described with respect to the use for the liquid crystal display unit. As far as a planar light source apparatus needs to be large and have high and uniform brightness, the planar light source apparatus according to the present invention can be applied irrespective of the indoor or outdoor use.

What is claimed is:

1. A planar light source apparatus, comprising:
a plurality of light sources; and
a plurality of illumination units arranged adjacently to each other between said plurality of light sources and a target illuminated by said plurality of light sources, and
wherein said plurality of light sources are arranged to illuminate edge portions of said plurality of illumination units, respectively.

2. A planar light source apparatus according to claim 1, wherein said edge portions include incidence planes of light by said plurality of light sources.

3. A planar light source apparatus according to claim 1, wherein each of said plurality of illumination units overlaps with each other such that a surface of a first illumination unit of said plurality of illumination units is placed opposite to a rear face of a second illumination unit of said plurality of illumination units.

4. A planar light source apparatus according to claim 3, wherein said light source illuminates said edge portion of said first illumination unit and at least one portion of said rear face of said second illumination unit.

5. A planar light source apparatus according to claim 1, wherein a single substantially flat face is formed with said plurality of illumination units and said single substantially flat face is opposed to said target.

6. A planar light source apparatus, comprising:
a plurality of light sources; and
a plurality of wedge-shaped illumination units having edge portions, wherein a thickness of each of said plurality of wedge-shaped illumination units decreases as departing from said edge portion, said plurality of light sources illuminating said edge portions.

7. A planar light source apparatus according to claim 6, wherein each of said plurality of illumination units overlaps with each other such that a surface of a first illumination unit of said plurality of illumination units is placed opposite to a rear face of a second illumination unit of said plurality of illumination units.

8. A planar light source apparatus according to claim 7, wherein said light source illuminates said edge portion of said first illumination unit and at least one portion of said rear face of said second illumination unit.

9. A planar light source apparatus according to claim 6, wherein a single substantially flat face is formed with said plurality of illumination units and said single substantially flat face is opposed to a target illuminated by said plurality of light sources.

10. A planar light source apparatus according to claim 3, wherein at least one of said surface of said first illumination unit and said rear face of said second illumination unit is processed for controlling a light volume when said light source illuminates said target.

11. A planar light source apparatus according to claim 1, wherein said each of plurality of illumination units overlaps with each other in an overlapping portion of said each of plurality of illumination units, and
wherein a gradation process is applied to said overlapping portion by changing the number of dots formed per unit area of said overlapping portion.

12. A planar light source apparatus according to claim 1, further comprising:
a casing provided along external periphery portions of said plurality of light sources and said plurality of illumination units.

13. A planar light source apparatus according to claim 12, further comprising:
a supporting member to support said illumination unit, wherein said supporting member is provided between said illumination unit and said casing.

14. A planar light source apparatus according to claim 13, wherein said supporting member is made of the same material as said illumination unit.

15. A planar light source apparatus according to claim 13, wherein said supporting member and said illumination unit are substantially formed in one piece.

16. A planar light source apparatus according to claim 1, wherein said illumination unit includes a light guide plate.

17. A planar light source apparatus according to claim 16, wherein said light guide plate is made of highly transparent resin.

18. A liquid crystal display apparatus, comprising:
a liquid crystal panel; and
a planar light source unit provided in a rear side of said liquid crystal panel, and
wherein said planar light source unit includes:
a plurality of light sources; and
a plurality of illumination units arranged adjacently to each other between said plurality of light sources and said liquid crystal panel, and
wherein said plurality of light sources are arranged to illuminate edge portions of said plurality of illumination units, respectively.

19. A liquid crystal display apparatus according to claim 18, wherein said edge portions include incidence planes of light by said plurality of light sources.

20. A liquid crystal display apparatus according to claim 18, wherein each of said plurality of illumination units overlaps with each other such that a surface of a first illumination unit of said plurality of illumination units is placed opposite to a rear face of a second illumination unit of said plurality of illumination units.
